(19) United States
(12) Patent Application Publication
(10) Pub. No.: US 2017/0277172 A1
(43) Pub. Date: Sep. 28, 2017

(54) SIM SYSTEM, CONTROL METHOD THEREFOR AND PRODUCTION INFORMATIZATION SYSTEM

(71) Applicants: BOE TECHNOLOGY GROUP CO., LTD., Beijing (CN); HEFEI XINSHENG OPTOELECTRONICS TECHNOLOGY CO., LTD., Hefei, Anhui (CN)

(72) Inventors: Yongjin LEE, Beijing (CN); Taehyuck YOON, Beijing (CN); Yi ZHANG, Beijing (CN); Mingting WENG, Beijing (CN); Unsub LEE, Beijing (CN); Liang ZHANG, Beijing (CN)

(21) Appl. No.: 15/511,590

(22) PCT Filed: Jan. 15, 2016
(86) PCT No.: PCT/CN2016/071044

§ 371 Date: Mar. 15, 2017

(30) Foreign Application Priority Data
Aug. 20, 2015 (CN) 201510515827.0

(51) Int. Cl. G05B 19/418; H04B 1/48

(52) U.S. Cl. CPC G05B 19/4188; H04B 1/48; G05B 2219/31001

(57) ABSTRACT

The present disclosure provides a CIM system, a control method and a production informatization system. The CIM system comprises an integrated control device and an integrated communication device. The integrated control device comprises an interface module and an integrated control module; wherein the interface module is arranged to receive a control command and identify a controlled device at which the control command is directed; the integrated control module is arranged to obtain, based on the control command, a control instruction that is recognizable by the controlled device and transmit the control instruction to the integrated communication device. The integrated communication device is arranged to determine a communication protocol type between it and the controlled device, and encapsulate the control instruction into a control message of corresponding communication protocol type to transmit to the controlled device. The computer integrated manufacturing system provided by the present disclosure can improve the control efficiency for the controlled device.

### FIELD

The present disclosure relates to the field of control technologies, and particularly to a CIM system and a control method therefor, and a production informatization system.

### BACKGROUND

The production process of a display panel usually involves multiple procedures, and each procedure generally involves multiple devices. During the production process, individual devices may be set and adjusted. In the prior art, control over respective devices are generally implemented by inputting instructions and parameters to these devices directly. For example, for a controlled device for which control instructions are relatively fixed, an operator is required to directly input a corresponding control instruction(s) (such as initialization instruction, etc.) to the device to realize control over it. Such a control process requires the operator to perform corresponding operations on individual devices one by one, resulting in a very low efficiency.

### SUMMARY

It is an object of the present disclosure to overcome at least one aspect of the above technical problem.

According to a first aspect of the present disclosure, there is provided a computer integrated manufacturing CIM system comprising: an integrated control device and an integrated communication device, the integrated control device comprising an interface module and an integrated control module.

The interface module is arranged to receive a control command and identify a controlled device at which the control command is directed. The integrated control module is arranged to obtain, based on the control command, a control instruction that is recognizable by the controlled device. The integrated communication device is arranged to determine a communication protocol type between it and the controlled device, and encapsulate the control instruction into a control message of corresponding communication protocol type to transmit to the controlled device.

In another embodiment, the control command includes a control parameter being set to control a robotic device. The integrated communication device comprises a robotic integrated communication module, and the robotic integrated communication module comprises a plurality of robotic communication interface units.

The integrated control module comprises a robotic device control module. The robotic device control module is arranged to generate a control instruction for a robotic protocol based on the control parameter included in the control command and transmit the generated control instruction to a robotic communication interface unit to which a corresponding robotic device connects.

The robotic communication interface unit is arranged to, upon receipt of the control instruction, encapsulate the received control instruction into a control message of a communication protocol type corresponding to the robotic communication interface unit and transmit the control message to the corresponding robotic device.

In another embodiment, the robotic communication interface unit in the robotic integrated communication module includes one or more of the following communication interface units: a control and communication link communication interface unit, an RS232 communication interface unit, a digital in and out interface communication interface unit, and an Ethernet communication interface unit.

In another embodiment, the interface module is arranged to present an optional command item(s) and obtain a selected optional command item as a control command. The optional command items are arranged to control an instruction-controlled device having a fixed control instruction(s). The integrated communication device comprises an instructed-device integrated communication module. The instructed-device integrated communication module comprises a plurality of instructed-device communication interface units. The integrated control module comprises an instructed-device control module. The instructed-device control module is arranged to obtain and store fixed control instructions corresponding to respective optional command items; find a fixed control instruction corresponding to the control command obtained by the interface module, and transmit the found fixed control instruction to an instructed-device communication interface unit to which a corresponding instruction-controlled device connects.

The instructed-device communication interface unit is arranged to, upon receipt of the control instruction, encapsulate the received control instruction into a control message of a communication protocol type corresponding to the instructed-device communication interface unit and transmit the control message to the corresponding instruction-controlled device.

In another embodiment, the instructed-device communication interface unit in the instructed-device integrated communication module includes one or more of the following communication interface units: a control and communication link communication interface unit, an RS232 communication interface unit, a digital in and out interface communication interface unit, and a programmable logic controller communication interface unit.

In another embodiment, the integrated communication device comprises an uplink communication module, and the uplink communication module comprises a plurality of uplink communication interface units.

The uplink communication interface unit is arranged to receive a control message sent by a manufacturing execution system to the controlled device and transmit the received control message to the integrated control module.

The integrated control module is further arranged to parse the control message transmitted by the uplink communication interface unit to obtain a corresponding control instruction and transmit the control instruction obtained via parsing to the integrated communication device.

The interface module is further arranged to present a control command corresponding to the control instruction obtained via parsing by the integrated control module.

In another embodiment, the plurality of uplink communication interface units include one or more of the following communication interface units: an SECS1 communication interface unit, an SECS2 communication interface unit, an RS232 communication interface unit, a file transfer protocol communication interface unit, and a Share N/W communication interface unit.

According to a second aspect of the present disclosure, there is provided a control method for a computer integrated manufacturing CIM system. The CIM system comprises an integrated control device and an integrated communication device. The method comprises: the integrated control device receiving a control command and identifying a controlled device to which the control command is directed; obtaining, based on the received control command, a control instruction that is recognizable by the controlled device and transmitting the control instruction to the integrated communication device; the integrated communication device determining a communication protocol type between it and the controlled device, encapsulating the control instruction into a control message of corresponding communication protocol type and transmitting the control message to the controlled device.

According to an embodiment of the present disclosure, the control command includes a control parameter being set to control a robotic device. The integrated control device generates a control instruction for a robotic protocol based on the control parameter included in the control command and transmits the generated control instruction to a robotic communication interface unit to which a corresponding robotic device connects.

The robotic communication interface unit in the integrated communication device encapsulates the control instruction into a control message of corresponding communication protocol type and transmits the control message to the corresponding robotic device.

According to another embodiment of the present disclosure, the integrated control device presents an optional command item(s) and obtains a selected optional command item as a control command. The optional command items are arranged to control an instruction-controlled device having a fixed control instruction(s).

The integrated control device obtains and stores fixed control instructions corresponding to respective optional command items; finds a fixed control instruction corresponding to the control command obtained by the interface module and transmits the found fixed control instruction to an instructed-device communication interface unit to which a corresponding instruction-controlled device connects.

The instructed-device communication interface unit in the integrated communication device encapsulates the control instruction into a control message of corresponding communication protocol type and transmits the control message to the corresponding instruction-controlled device.

According to a further embodiment of the present disclosure, the method further comprises performing the following steps by the integrated control device: receiving a control message sent by a manufacturing execution system to the controlled device; parsing the received control message to obtain a corresponding control instruction, transmitting the control instruction obtained via parsing to a communication interface unit that connects to the controlled device at which the control message is directed; and presenting a control command corresponding to the control instruction obtained via parsing.

According to a third aspect of the present disclosure, there is provided a production informatization system. The system comprises: at least one CIM system described above; a manufacturing execution system; and a production monitoring system. The production monitoring system is arranged to monitor state parameters of respective computer integrated manufacturing systems.

According to an embodiment of the present disclosure, the number of the computer integrated manufacturing systems is plural and at least two CIM systems control the same production line(s).

The production monitoring system is arranged to, after one of two computer integrated manufacturing systems which control the same production line(s) has failed and rebooted, replicate corresponding state parameters in the other computer integrated manufacturing system to the failed computer integrated manufacturing system.

According to another embodiment of the present disclosure, the production monitoring system further comprises: a storage module and a monitoring and management module.

The storage module is arranged to acquire a correspondence between production parameter(s) and a driving environment for each controlled device of at least one controlled device.

The monitoring and management module is arranged to, when a driving environment of a controlled device of the at least one controlled device is changed, acquire from the storage module production parameters corresponding to a changed driving environment of the controlled device, update currently used production parameters with the acquired production parameters, and transmit the acquired production parameters to a computer integrated manufacturing system corresponding to the controlled device.

The integrated control device in the respective computer integrated manufacturing systems is further arranged to, upon receipt of production parameters issued by the production monitoring system, generate a corresponding control instruction based on the received production parameters to transmit to the integrated communication device.

In another embodiment, the monitoring and management module is further arranged to automatically obtain from the storage module production parameters of respective controlled devices of the at least one controlled device in a current driving environment after initialization.

In another embodiment, the production monitoring system is further arranged to acquire and present alarm information issued by one controlled device of the respective controlled devices controlled by the respective computer integrated manufacturing systems to another controlled device.

The computer integrated manufacturing system provided in accordance with embodiments of the present disclosure comprises an integrated control device and an integrated communication device, which are capable of receiving a control command and correspondingly generating a control instruction that is recognizable by a corresponding controlled device, and encapsulating the control instruction into a control message of corresponding communication protocol type to transmit to the controlled device, thereby realizing control over the controlled device. The computer integrated manufacturing system provided by the present disclosure can greatly improve the control efficiency for a plurality of controlled devices.

### BRIEF DESCRIPTION OF THE DRAWINGS

FIG. 1 is a block diagram of a computer integrated manufacturing system provided in accordance with embodiments of the present disclosure;

FIG. 2 is a block diagram of another computer integrated manufacturing system provided in accordance with embodiments of the present disclosure;

FIG. 3 is a schematic flow chart of a control method for a computer integrated manufacturing system provided in accordance with embodiments of the present disclosure; and

FIG. 4 is a block diagram of a production informatization system provided in accordance with embodiments of the present disclosure.

### DETAILED DESCRIPTION

In order to make the objects, technical solutions and advantages of embodiments of the present disclosure clearer, the technical solutions in the embodiments of the present disclosure will be described below in a clear and complete manner in combination with the accompanying drawings in the embodiments of the present disclosure. Obviously, the described embodiments are merely part of the embodiments of the present disclosure, rather than all of them. All other embodiments achieved by those ordinary skilled in the art based on embodiments of the present disclosure without creative work fall within the protection scope of the present disclosure.

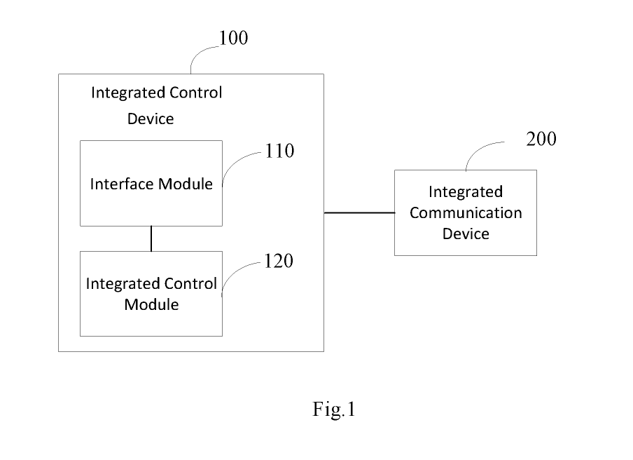

According to an aspect of the present disclosure, there is provided a computer integrated manufacturing (CIM) system. FIG. 1 is a block diagram of a computer integrated manufacturing system provided in accordance with embodiments of the present disclosure. The system comprises an integrated control device 100 and an integrated communication device 200. The integrated control device 100 comprises an interface module 110 and an integrated control module 120.

The interface module 110 is arranged to receive a control command and identify a controlled device at which the control command is directed. The integrated control module 120 is arranged to obtain, based on the control command, a control instruction that is recognizable by the controlled device, and transmit the control instruction to the integrated communication device 200.

The integrated communication device 200 is arranged to determine a communication protocol type between it and the controlled device and encapsulate the control instruction into a control message of corresponding communication protocol type to transmit to the controlled device.

The computer integrated manufacturing system provided in accordance with embodiments of the present disclosure comprises an integrated control device and an integrated communication device, which are capable of receiving a control command and correspondingly generating a control instruction that is recognizable by a corresponding controlled device, and encapsulating the control instruction into a control message of corresponding communication protocol type to transmit to the controlled device, thereby realizing control over the controlled device. The computer integrated manufacturing system provided in accordance with embodiments of the present disclosure can greatly improve the control efficiency for a plurality of controlled devices.

In particular, the interface module 110 may be arranged to provide a user operation interface such that the user can select a respective controlled device on the user operation interface and a control command that needs to be executed on the controlled device. After the user selects the respective controlled device and enters the control command, the interface module 110 may obtain the information and transmit it to the integrated control module 120.

According to an embodiment of the present disclosure, the control command obtained by the interface module 110 may be a control command including a control parameter being set to control a robotic device. The robotic device at which the control parameter carried in the control command is directed acts as the controlled device at which the control command is directed.

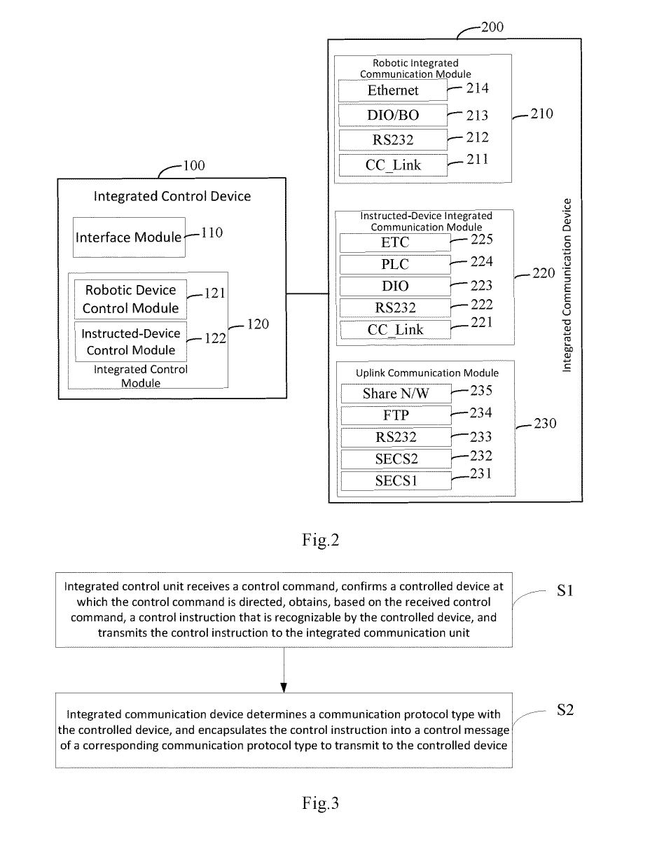

FIG. 2 is a block diagram of another computer integrated manufacturing system provided in accordance with embodiments of the present disclosure. The integrated control module 120 may comprise a robotic device control module 121, and the integrated communication device 200 may comprise a robotic integrated communication module 210 arranged to realize communication with the robotic device. The robotic integrated communication module comprises a plurality of robotic communication interface units 211-214. The robotic device control module 121 generates a control instruction for a robotic protocol based on the control parameter in the control command obtained by the interface module 110, and then transmits the generated control instruction to a robotic communication interface unit to which the corresponding robotic device connects.

The robotic communication interface unit is arranged to, upon receipt of the control instruction, encapsulate the received control instruction into a control message of a communication protocol type corresponding to the robotic communication interface unit and transmit the control message to the corresponding robotic device.

In this way, for the operator, it is not necessary to set corresponding parameters at respective robotic devices, and it is only required to set parameters in the computer integrated manufacturing system to thereby realize control over the respective robotic devices, which improves the control efficiency. In specific implementation, the robotic devices described here may refer to a class of devices with a robotic arm(s), all of which are capable of recognizing the control command for the robotic protocol. The control parameter described here may refer to a parameter that is set to control a distance a robotic arm of a robotic device moves.

According to an embodiment of the present disclosure, the robotic integrated communication module 210 may comprise one or more of a control and communication link (CC_Link) communication interface unit 211, an RS232 communication interface unit 212, a digital in and out (DIO) communication interface unit 213, and an Ethernet communication interface unit 214. FIG. 2 illustrates a situation where the respective communication interface units are CC_Link (communication interface unit), RS232, DIO and Ethernet respectively.

According to an embodiment of the present disclosure, the interface module 110 may be further arranged to present an optional command item(s) and obtain a selected optional command item as a control command. The optional command items described here are set to control an instruction-controlled device having fixed control instructions.

Now referring to FIG. 2, the integrated communication device 200 may also comprise an instructed-device integrated communication module 220. The instructed-device integrated communication module 220 further comprises a plurality of instructed-device communication interface units 221-225.

The integrated control module 120 may comprise an instructed-device control module 122. The instructed-device control module 122 is arranged to obtain and store fixed control instructions corresponding to respective optional command items; and find a fixed control instruction corresponding to the control command obtained by the interface module 110 and transmit the found fixed control command to an instructed-device communication interface unit to which the corresponding instruction-controlled device connects.

The instructed-device communication interface unit is arranged to, upon receipt of the control instruction, encapsulate the received control instruction into a control message of a communication protocol type corresponding to the instructed-device communication interface unit and transmit the control message to the corresponding instruction-controlled device.

In specific implementation, instruction-controlled devices produced by different manufacturers have control instructions in different forms (mainly embodied in different instruction codes; for different devices, a same control command may be achieved with different control instruction codes). As such, in specific implementation, (codes of) fixed control instructions of respective controlled devices can be obtained first, and the interface module is used to present command items (i.e. optional command items) to which respective fixed control instructions correspond. After a user selects a corresponding optional command item, a fixed control instruction corresponding to the optical command item can be directly found. Thereafter, the found fixed control instruction is transmitted to a communication interface unit in the integrated communication device, to which the instruction-controlled device connects. In this way, control over the controlled device having fixed control instructions can be realized. In the same way, the control efficiency of the corresponding controlled device can also be improved. The instruction described here may be a respective type of instruction, such as initialization instruction and the like.

According to an embodiment of the present disclosure, the interface module 110 may present the above-described optional command items in a number of ways. For example, it may broadcast respective optional command items in turn by means of voice or expose the respective optional command items. The way in which the optional command items are presented would not affect the implementation of the present disclosure, and corresponding technical solutions should also fall within the protection scope of the present disclosure.

The respective communication interface units comprised by the instructed-device integrated communication module 220 may include one or more of the following communication interface units: a CC_Link communication interface unit 221, an RS232 communication interface unit 222, a DIO communication interface unit 223, a programmable logic controller (PLC) communication interface unit 224, and an ECT communication interface unit 225. FIG. 2 illustrates a situation where the respective communication interface units are CC_Link, RS232, DIO, PLC and ECT respectively.

In specific implementation, the integrated communication device 200 may further comprise an uplink communication module 230. The uplink communication module 230 comprises a plurality of uplink communication interface units 231-235.

The uplink communication interface unit is arranged to receive a control message sent by a manufacturing execution system and transmit the received control message to the integrated control module.

The integrated control module 120 is further arranged to parse the control message transmitted by the uplink communication interface unit to obtain a corresponding control instruction, and transmit the control instruction obtained via parsing to the integrated communication device 200 so as to be transmitted to a corresponding controlled device via the integrated communication interface.

The interface module 110 is further arranged to present a control command corresponding to the control instruction obtained via parsing by the integrated control module 120.

In this way, on the one hand, a computer integrated manufacturing system can receive a control message sent by a manufacturing execution system to a corresponding controlled device and transmit it to the controlled device to realize control over the controlled device by the manufacturing execution system. On the other hand, the control message sent by the manufacturing execution system may be further parsed and exposed for reference by an operator of the computer integrated manufacturing system.

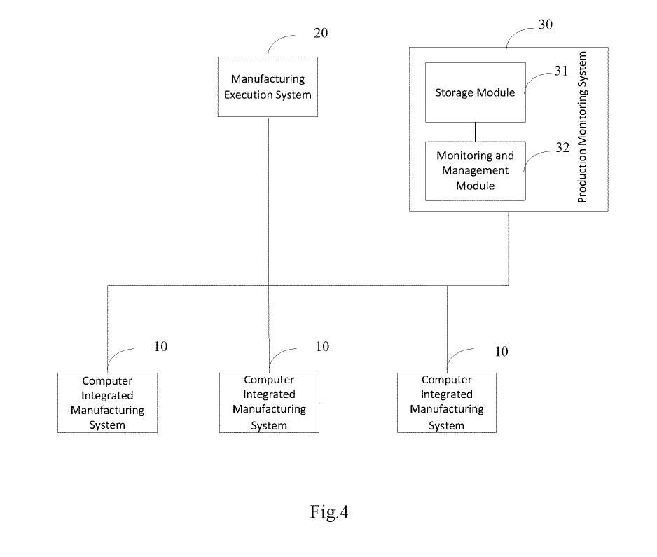

In specific implementation, the above uplink communication module 230 includes one or more of the following communication interface units: a semiconductor equipment communication standard (SECS) 1 communication interface unit 231, a SECS2 communication interface unit 232, an RS232 communication interface unit 233, a File Transfer Protocol (FTP) communication interface unit 234, and a Share N/W communication interface unit 235. FIG. 3 illustrates a situation where the respective communication interface units are SECS1, SECS2, RS232, FTP and Share N/W respectively.

According to an embodiment of the present disclosure, the integrated control module 120 may be further arranged to acquire state parameters of respective controlled devices and transmit the acquired state parameters to the manufacturing execution system.

Embodiments of the present disclosure further provide a control method for a computer integrated manufacturing CIM system comprising an integrated control device and an integrated communication device. FIG. 3 is a schematic flow chart of a control method for a computer integrated manufacturing system provided in accordance with embodiments of the present disclosure. The method may comprise the follow steps.

In step S1, the integrated control device receives a control command, confirms a controlled device at which the control command is directed, obtains, based on the received control command, a control instruction that is recognizable by the controlled device, and transmits the control instruction to the integrated communication device.

In step S2, the integrated communication device determines a communication protocol type between it and the controlled device, and encapsulates the control instruction into a control message of corresponding communication protocol type to transmit to the controlled device.

The control method for a computer integrated manufacturing system provided in accordance with embodiments of the present disclosure allows to receive a control command, generate a control instruction that is recognizable by a corresponding controlled device accordingly, and encapsulate the control instruction into a control message of corresponding communication protocol type to transmit to the controlled device, thereby achieving control over the controlled device. Application of the control method according to embodiments of the present disclosure can greatly improve the control efficiency for a plurality of controlled devices.

In another embodiment, the control command may be a control instruction including a control parameter being set to control a robotic device.

The above-described step Si may specifically comprise: generating a control instruction for a robotic protocol based on the control parameter included in the control command and transmitting the generated control instruction to a robotic communication interface unit to which a corresponding robotic device connects.

The above-described step S2 may specifically comprise: the robotic communication interface unit in the integrated communication device encapsulating the control instruction into a control message of corresponding communication protocol type to transmit to the corresponding robotic device.

According to an embodiment of the present disclosure, the step of receiving a control command in step Si above may specifically comprise: presenting an optional command item(s) and obtaining a selected optional command item as a control command. The optional command items are arranged to control an instruction-controlled device having a fixed control instruction(s).

The step of obtaining and transmitting the control instruction in step S1 may comprise: obtaining and storing fixed control instructions corresponding to respective optional command items, finding a fixed control instruction corresponding to the control command obtained by the interface module, and transmitting the found fixed control instruction to an instructed-device communication interface unit to which the corresponding instruction-controlled device connects.

At that time, the above-described step S2 may comprise: the instructed-device communication interface unit in the integrated communication device encapsulating the control instruction into a control message of corresponding communication protocol type to transmit to the corresponding instruction-controlled device.

According to an aspect of the present disclosure, there is provided a production informatization system. FIG. 4 is a block diagram of a production informatization system provided in accordance with embodiments of the present disclosure. The production informatization system comprises a plurality of computer integrated manufacturing systems 10, and further comprises a manufacturing execution system (MES) 20 and a production monitoring system 30.

The production monitoring system 30 is arranged to monitor state parameters of respective computer integrated manufacturing systems 10.

In specific implementation, the computer integrated manufacturing system 10 described here may be further arranged to collect production parameters of respective controlled devices and report them to the manufacturing execution system 20.

According to another embodiment of the present disclosure, at least two computer integrated manufacturing systems control a same production line(s). The production monitoring system 30 is arranged to, after one of two computer integrated manufacturing systems which control the same production line(s) has failed and rebooted, replicate corresponding state parameters of the other computer integrated manufacturing system to the failed computer integrated manufacturing system.

In this way, restoration of parameters in the failed computer integrated manufacturing system is automatically implemented, obviating a need for manual re-introduction of data and reducing labor intensity. As will be appreciated, same production line(s) as used here in embodiments of the present disclosure may refer to two production lines that have same devices and require same parameters to be set for the devices, but not necessarily referring to one and the same production line.

Further, the production monitoring system 30 further comprises a storage module 31 and a monitoring and management module 32. The storage module may be arranged to obtain a correspondence between production parameters and a driving environment for each of the controlled devices.

The monitoring and management module 32 may be arranged to, when the driving environment of a controlled device of the at least one controlled device is changed, acquire from the storage module 31 the production parameters corresponding to the changed driving environment of the driven device, update currently used production parameters with the acquired production parameters, and transmit the acquired production parameters to the computer integrated manufacturing system corresponding to the controlled device.

The integrated control devices in the respective computer integrated manufacturing systems may be further arranged to, upon receipt of the production parameters issued by the production monitoring system, generate corresponding control commands based on the received production parameters and issue the control commands to respective controlled devices.

In specific implementation, “driving environment being changed” described here may indicate that the production state in which a respective production line locates is changed, for example, the external physical and chemical environment, the product model of the product to be produced, etc. are changed. A production parameter described here may refer to a parameter that need to be set for a production device in a respective driving environment. For example, for a robotic device, the corresponding production parameters thereof may refer to walking speed, walking distance, walking time, and so on.

In this way, the production parameters can be automatically updated when the driving environment is changed. In particular, in practical applications, the driving environment of a production line may exhibit a periodical change, at this time the monitoring and management module can read from the storage module the production parameters required for the next period according to a preset period and issue them to a corresponding controlled device.

In another embodiment, the monitoring and management module 32 may be further arranged to automatically obtain from the storage module the production parameters in current driving environment for each of the at least one controlled device after the initialization.

In this way, the production parameters in current driving environment can be automatically introduced into a controlled device that has been initialized. This process involves no manual operation and reduces labor intensity.

In another embodiment, the production monitoring system 30 may be further arranged to acquire and present alarm information that one controlled device of the controlled devices controlled by the respective computer integrated manufacturing systems sends out to another controlled device.

In this way, it is possible to display alarm among devices in multiple production lines involved in the production process, which facilitates the operator's analysis of cause of alarm.

The above embodiments are only specific embodiments of the present disclosure, but the protection scope of the present disclosure is not so limited. Any skilled person familiar with this technical field can easily conceive variations or replacements within the technical scope disclosed by the present disclosure, which shall be encompassed within the protection scope of the present disclosure. Thus, the protection scope of the present disclosure shall be based on the protection scope of the claims.

1. A computer integrated manufacturing CIM system, comprising:
an integrated control device and
an integrated communication device,
wherein the integrated control device comprising an interface module and an integrated control module; wherein the interface module is arranged to receive a control command and identify a controlled device at which the control command is directed; the integrated control module is arranged to obtain, based on the control command, a control instruction that is recognizable by the controlled device and transmit the control instruction to the integrated communication device; and the integrated communication device is arranged to determine a communication protocol type between it and the controlled device, encapsulate the control instruction into a control message of corresponding communication protocol type, and transmit the control message to the controlled device.

2. The system according to claim 1, wherein the control command includes a control parameter being set to control a robotic device; the integrated communication device comprises a robotic integrated communication module, the robotic integrated communication module comprising a plurality of robotic communication interface units; and the integrated control module comprises a robotic device control module;
wherein the robotic device control module is arranged to generate a control instruction for a robotic protocol based on the control parameter included in the control command and transmit the generated control instruction to a robotic communication interface unit to which a corresponding robotic device connects;
wherein the robotic communication interface unit is arranged to, upon receipt of the control instruction, encapsulate the received control instruction into a control message of a communication protocol type corresponding to the robotic communication interface unit and transmit the control message to the corresponding robotic device.

3. The system according to claim 2, wherein the robotic communication interface unit in the robotic integrated communication module includes one or more of the following communication interface units:
a control and communication link communication interface unit, an RS232 communication interface unit, a digital in and out interface communication interface unit, and an Ethernet communication interface unit.

4. The system according to claim 1, wherein the interface module is arranged to present one or more optional command item and obtain a selected optional command item as the control command; the optional command items are arranged to control an instruction-controlled device having one or more fixed control instructions; the integrated communication device comprises an instructed-device integrated communication module comprising a plurality of instructed-device communication interface units; the integrated control module comprises an instructed-device control module;
wherein the instructed-device control module is arranged to obtain and store fixed control instructions to which respective optional command items correspond; find a fixed control instruction corresponding to the control command obtained by the interface module, and transmit the found fixed control instruction to an instructed-device communication interface unit to which a corresponding instruction-controlled device connects;
wherein the instructed-device communication interface unit is arranged to, upon receipt of the control instruction, encapsulate the received control instruction into a control message of a communication protocol type corresponding to the instructed-device communication interface unit and transmit the control message to the corresponding instruction-controlled device.

5. The system according to claim 4, wherein the instructed-device communication interface unit in the instructed-device integrated communication module includes one or more of following communication interface units:
a control and communication link communication interface unit, an RS232 communication interface unit, a digital in and out interface communication interface unit, and a programmable logic controller communication interface unit.

6. The system according to claim 1, wherein the integrated communication device comprises an uplink communication module, the uplink communication module comprising a plurality of uplink communication interface units;
wherein an uplink communication interface unit is arranged to receive a control message sent by a manufacturing execution system to a controlled device and transmit the received control message to the integrated control module;
wherein the integrated control module is further arranged to parse the control message transmitted by the uplink communication interface unit to obtain a corresponding control instruction and transmit the control instruction obtained via parsing to the integrated communication device;
wherein the interface module is further arranged to present a control command corresponding to the control instruction obtained via parsing by the integrated control module.

7. The system according to claim 6, wherein the plurality of uplink communication interface units include one or more of the following communication interface units:
a SECS1 communication interface unit, an SECS2 communication interface unit, an RS232 communication interface unit, a file transfer protocol communication interface unit, and a Share N/W communication interface unit.

8. A control method for a computer integrated manufacturing CIM system, the CIM system comprising an integrated control device and an integrated communication device, the method comprising:
the integrated control device receiving a control command and identifying a controlled device to which the control command is directed, obtaining, based on the received control command, a control instruction that is recognizable by the controlled device and transmitting the control instruction to the integrated communication device; and
the integrated communication device determining a communication protocol type between it and the controlled device, encapsulating the control instruction into a control message of corresponding communication protocol type and transmitting the control message to the controlled device.

9. The method according to claim 8, wherein the control command includes a control parameter being set to control a robotic device;
wherein the integrated control device generates a control instruction for a robotic protocol based on the control parameter included in the control command and transmits the generated control instruction to a robotic communication interface unit to which a corresponding robotic device connects; and
wherein the robotic communication interface unit in the integrated communication device encapsulates the control instruction into a control message of corresponding communication protocol type and transmits the control message to the corresponding robotic device.

10. The method according to claim 8, wherein the integrated control device receiving the control command comprises: presenting one or more optional command items and obtaining a selected optional command item as the control command; the optional command items being arranged to control an instruction-controlled device having one or more fixed control instructions;
wherein the integrated control device obtains and stores fixed control instructions corresponding to respective optional command items; finds a fixed control instruction corresponding to the control command obtained by the interface module and transmits the found fixed control instruction to an instructed-device communication interface unit to which a corresponding instruction-controlled device connects;
wherein the instructed-device communication interface unit in the integrated communication device encapsulates the control instruction into a control message of corresponding communication protocol type and transmits the control message to the corresponding instruction-controlled device.

11. The method according to claim 8, further comprising the integrated control device receiving a control message sent by a manufacturing execution system to the controlled device;
parsing the received control message to obtain a corresponding control instruction,
transmitting the control instruction obtained via parsing to a communication interface unit that connects to the controlled device at which the control message is directed; and
presenting a control command corresponding to the control instruction obtained via parsing.

12. A production informatization system, comprising:
at least one CIM system according to claim 1;
a manufacturing execution system; and
a production monitoring system;
wherein the production monitoring system is arranged to monitor state parameters of respective computer integrated manufacturing systems.

13. The production informatization system according to claim 12, wherein it comprises a plurality of computer integrated manufacturing systems and at least two CIM systems control a same production line(s);
wherein the production monitoring system is arranged to, after one of two computer integrated manufacturing systems which control the same production line(s) has failed and rebooted, replicate corresponding state parameters in the other computer integrated manufacturing system to the failed computer integrated manufacturing system.

14. The production informatization system according to claim 12, wherein the production monitoring system further comprises:
a storage module arranged to acquire a correspondence between production parameters and a driving environment for each controlled device of at least one controlled device; and
a monitoring and management module arranged to, when a driving environment of a controlled device of the at least one controlled device is changed, acquire from the storage module production parameters corresponding to a changed driving environment of the controlled device, update currently used production parameters with the acquired production parameters, and transmit the acquired production parameters to a computer integrated manufacturing system corresponding to the controlled device;
wherein the integrated control device in the respective computer integrated manufacturing systems is further arranged to, upon receipt of production parameters issued by the production monitoring system, generate a corresponding control instruction based on the received production parameters to transmit to the integrated communication device.

15. The production informatization system according to claim 14, wherein the monitoring and management module is further arranged to automatically obtain from the storage module production parameters of respective controlled devices of the at least one controlled device in a current driving environment after initialization.

16. The production informatization system according to claim 15, wherein the production monitoring system is further arranged to acquire and present alarm information issued by one controlled device of the respective controlled devices controlled by the respective computer integrated manufacturing systems to another controlled device.

17. The production informatization system according to claim 12, wherein the control command includes a control parameter being set to control a robotic device; the integrated communication device comprises a robotic integrated communication module, the robotic integrated communication module comprising a plurality of robotic communication interface units; and the integrated control module comprises a robotic device control module;
wherein the robotic device control module is arranged to generate a control instruction for a robotic protocol based on the control parameter included in the control command and transmit the generated control instruction to a robotic communication interface unit to which a corresponding robotic device connects;
wherein the robotic communication interface unit is arranged to, upon receipt of the control instruction, encapsulate the received control instruction into a control message of a communication protocol type corresponding to the robotic communication interface unit and transmit the control message to the corresponding robotic device.

18. The production informatization system according to claim 12, wherein the interface module is arranged to present one or more optional command item and obtain a selected optional command item as the control command; the optional command items are arranged to control an instruction-controlled device having one or more fixed control instructions; the integrated communication device comprises an instructed-device integrated communication module comprising a plurality of instructed-device communication interface units; the integrated control module comprises an instructed-device control module;
wherein the instructed-device control module is arranged to obtain and store fixed control instructions to which respective optional command items correspond; find a fixed control instruction corresponding to the control command obtained by the interface module, and transmit the found fixed control instruction to an instructed-device communication interface unit to which a corresponding instruction-controlled device connects;
wherein the instructed-device communication interface unit is arranged to, upon receipt of the control instruction, encapsulate the received control instruction into a control message of a communication protocol type corresponding to the instructed-device communication interface unit and transmit the control message to the corresponding instruction-controlled device.

19. The production informatization system according to claim 12, wherein the integrated communication device comprises an uplink communication module, the uplink communication module comprising a plurality of uplink communication interface units;
wherein an uplink communication interface unit is arranged to receive a control message sent by the manufacturing execution system to a controlled device and transmit the received control message to the integrated control module;
wherein the integrated control module is further arranged to parse the control message transmitted by the uplink communication interface unit to obtain a corresponding control instruction and transmit the control instruction obtained via parsing to the integrated communication device;
wherein the interface module is further arranged to present a control command corresponding to the control instruction obtained via parsing by the integrated control module.

20. The production informatization system according to claim 19, wherein the plurality of uplink communication interface units include one or more of the following communication interface units:
a SECS1 communication interface unit, an SECS2 communication interface unit, an RS232 communication interface unit, a file transfer protocol communication interface unit, and a Share N/W communication interface unit.
